(19) United States
(12) Patent Application Publication
(10) Pub. No.: US 2011/0045169 A1
(43) Pub. Date: Feb. 24, 2011

(54) FILM DISPERSED OF CARBON NANOTUBES AND LIGHT EMITTING BODY

(75) Inventors: Shigeo MARUYAMA, Tokyo (JP); Yuhei MIYAUCHI, Tokyo (JP); Yoshikazu KONDO, Tokyo (JP); Atsushi SAITO, Tokyo (JP)

Correspondence Address: LUCAS & MERCANTI, LLP, 475 PARK AVENUE SOUTH, 15TH FLOOR, NEW YORK, NY, 10016, US

(73) Assignees: THE UNIVERSITY OF TOKYO, Tokyo (JP); KONICA MINOLTA HOLDINGS, INC., Tokyo (JP)

(21) Appl. No.: 12/913,246

(22) Filed: Oct. 27, 2010

Related U.S. Application Data
(62) Division of application No. 11/571,758, filed on Jan. 8, 2007.

(30) Foreign Application Priority Data
Jul. 16, 2004 (JP) 2004-210223

(51) Int. Cl. B05D 5/06; B05D 1/12; B82Y 20/00

(52) U.S. Cl. 427/71; 427/180; 977/952

(57) ABSTRACT

Disclosed is a film of dispersed carbon nanotubes that emit intensive light with a particular wavelength. The film of dispersed carbon nanotubes is a film in which a plurality of carbon nanotubes are dispersed in a transparent binder, and each carbon nanotube is dispersed isolatedly in an oriented manner.

### FIELD OF THE INVENTION

The present invention relates to a film dispersed of carbon nanotubes in which a plurality of carbon nanotubes are dispersed in a transparent binder, and a light emitting body using the same.

### DESCRIPTION OF THE BACKGROUND

In the end of 20^{th} century, C₆₀ and carbon nanotube were added to the conventional carbon material, and thus “carbon” atom of IVB group structures the most various class of substance in the periodic table. As a substance that leads nanotechnology, which is assumed to be fundamental technology of the 21^{st} century, cylinder of carbon, that is, “carbon nanotube”, is recently receiving high expectation. Variability in structures and functions of carbon material is derived from that the carbon atom takes bonding forms of sp, sp², and sp³. This is a distinct characteristics of the carbon atom and differs largely from other atoms in the same IVB group, such as silicon and germanium. This variability in bonding forms is the root of the unique variability in carbon substances.

Carbon nanotube has a characteristic that even though it is structured with single element of carbon atom, optical characteristic changes to a large extent according to its structure. For example, it absorbs excitation light and emits light with a particular wavelength. This is due to the variability of carbon bond being reflected additionally by the hexagonal mesh plane of carbon having a nano-sized cylinder shape. That is, carbon nanotube itself is a substance that has wide variability, and thus it is expected to be applied in wide range of field. Although they are carbon with the same sp², graphite, carbon nanotube, C60, and the like show completely different physical property, in accordance with the difference in their geometric structure (dimension of expansion of bonding changes through two-dimension, pseudo one-dimension, and pseudo zero-dimension). Due to such difference in geometric structure, boundary condition concerning wave function of electron changes, and density of states function concerning electron changes for the band structure as solid, band structure that has van Hove divergence, and discrete electron level as a molecule.

One example of thin layer technology including afore-mentioned carbon nanotube is disclosed in non-patent documents 1 and 2.

In non-patent document 1, chloroform solution of carbon nanotube is spread on the surface of pure water, silica glass substrate is moved up and down in horizontal direction (Horizontal Lifting) or in vertical direction (Vertical Dipping) with respect to film surface of a film structured by the carbon nanotube, thus carbon nanotube is transferred onto the silica glass substrate. As a result, thin film that contains carbon nanotube (Langmuir-Blodgett Film) is obtained (refer to page 7630, left column, fourth paragraph, FIG. 1). In the non-patent document 1, polarized absorption spectrum is measured for each of the two samples, one in a case where the silica glass substrate is moved up and down in horizontal direction, and another in a case where it is moved up and down in vertical direction. From the measured result, it is verified that carbon nanotube is oriented in one direction in the thin film (refer to page 7632, right column, second paragraph-page 7633, right column, first paragraph, FIGS. 8 and 9).

On the other hand, in non-patent document 2, solution that contains carbon nanotube and gelatin is mixed, and the mixture is cast on a silica substrate, and dried to prepare thin film that contains carbon nanotube. In the non-patent document 2, fluorescence spectrum in a case where excitation light with wavelength of 785 nm is entered into the thin film is measured. From the measured result, it is understood that light with various wavelength is emitted, and verifies that carbon nanotube is dispersed isolatedly in the thin film (gelatin).
Non-patent document 1: Nobutsugu Minami and five others, “Langmuir-Blodgett Films of Single-Wall Carbon Nanotubes: Layer-by-layer Deposition and In-plane Orientation of Tubes”, Japanese Journal of Applied Physics, Japan Society Of Applied Physics, Dec. 10, 2003, vol. 42, p. 7629-7634
Non-patent document 2: Nobutsugu Minami and two others, “Thin Films of Isolated Individual SWNT: Photoluminescence and Optical Absorption Studies”, proceedings of 51^{st} Lecture Presentation of Applied Physics Related Association, March 2004, 29p-F-8, p. 538

### DISCLOSURE OF THE INVENTION

### Problem To Be Solved By the Invention

However, concerning the thin film disclosed in non-patent document 1, although carbon nanotubes are oriented in the thin film, they exist in a bundled state in the thin film (refer to page 7633, right column, second paragraph). Therefore, even though excitation light is irradiated to the thin film, light with a particular wavelength is not emitted by absorbing the excitation light, and the orientation state cannot be maintained stably. On the other hand, concerning thin film disclosed in the non-patent document 2, although carbon nanotubes are dispersed isolatedly in the thin film, they are not oriented.

An object of the present invention is to provide a film dispersed of carbon nanotubes that emits intensive light with a particular wavelength, and a light emitting body using the same.

### Means For Solving the Problem

In order to solve the above problem, a film of dispersed carbon nanotubes according to the first invention comprises a plurality of carbon nanotubes dispersed in a transparent binder, wherein each of the carbon nanotube is dispersed isolatedly in an oriented manner.

Here, “each carbon nanotube is oriented” indicates that in a case where polarized absorption spectrum is measured for the film dispersed of carbon nanotubes according to the first invention in the same conditions, absorption ranges in accordance with the angle of polarized light that is entered. That is, while polarized absorption spectrum of a film dispersed of carbon nanotubes which is not oriented is not effected by the entering angle of polarized light and the absorption peak intensity of a particular wavelength is constant, polarized absorption spectrum of a film dispersed of carbon nanotubes which is oriented has an entering angle of polarized light, of which an absorption peak does not exist (or an absorption peak that is weaker than the absorption peak exists) for a particular wavelength that corresponds to the absorption peak.

Here, “each carbon nanotube is dispersed isolatedly in the thin film” indicates that the film dispersed of carbon nanotubes emits light when light with a particular wavelength is irradiated to the film.

Preferably, concerning the film dispersed of carbon nanotubes of the first invention, the carbon nanotubes are single-walled carbon nanotubes.

Preferably, concerning the film dispersed of carbon nanotubes of the first invention, the carbon nanotubes are single-walled carbon nanotubes that is formed by ACCVD method.

Preferably, concerning the film dispersed of carbon nanotubes of the first invention, the transparent binder is gelatin.

Preferably, concerning the film dispersed of carbon nanotubes of the first invention, the film dispersed of carbon nanotubes emits light.

Light emitting body according to the second invention is the film dispersed of carbon nanotubes of the first invention formed on a predetermined substrate.

A film dispersed of carbon nanotubes according to the third invention is a film dispersed of carbon nanotubes comprising a plurality of carbon nanotubes, each of the plurality of carbon nanotubes being dispersed isolatedly in a transparent binder, wherein the carbon nanotubes are single-walled carbon nanotubes that are formed by ACCVD method.

Preferably, concerning the film dispersed of carbon nanotubes of the third invention, the transparent binder is gelatin.

Preferably, concerning the film dispersed of carbon nanotubes of the third invention, the film dispersed of carbon nanotubes emits light.

Light emitting body according to the fourth invention is the film dispersed of carbon nanotubes of the third invention formed on a predetermined substrate.

### Effect of the Invention

According to the first invention, since each carbon nanotube is dispersed isolatedly in an oriented manner, it can absorb excitation light with a particular wavelength and emit intensive light with a particular wavelength.

According to the second invention, since film dispersed of carbon nanotubes according to the first invention is supported on the substrate, rigidity is high, and thus application to various field is eased.

According to the third invention, since the carbon nanotube is a single-walled carbon nanotube that is prepared by ACCVD method, a plurality of carbon nanotubes with a particular structure (chirality) exist alternatively. As a result, it can absorb visible light, and emit intensive near-infrared ray with a particular wavelength.

According to the fourth invention, since film dispersed of carbon nanotubes according to the third invention is supported on the substrate, rigidity is high, and thus application to various field is eased.

### BRIEF DESCRIPTION OF THE DRAWINGS

FIG. 1 This is a perspective view showing a schematic structure of a light emitting body according to the first embodiment.

FIG. 2 This is a perspective view showing a schematic structure of a light emitting body according to the second embodiment.

FIG. 3 This is a graph showing polarized absorption spectrum of test sample A.

FIG. 4 This is a graph showing fluorescence spectrum of test sample A.

FIG. 5 This is a graph showing fluorescence spectrum of test sample C.

### BEST MODE TO CARRY OUT THE INVENTION

Hereinafter, best mode to carry out the present invention is described with reference to drawings. Here, the scope of the invention is not limited: to the example given in figures.

### First Embodiment

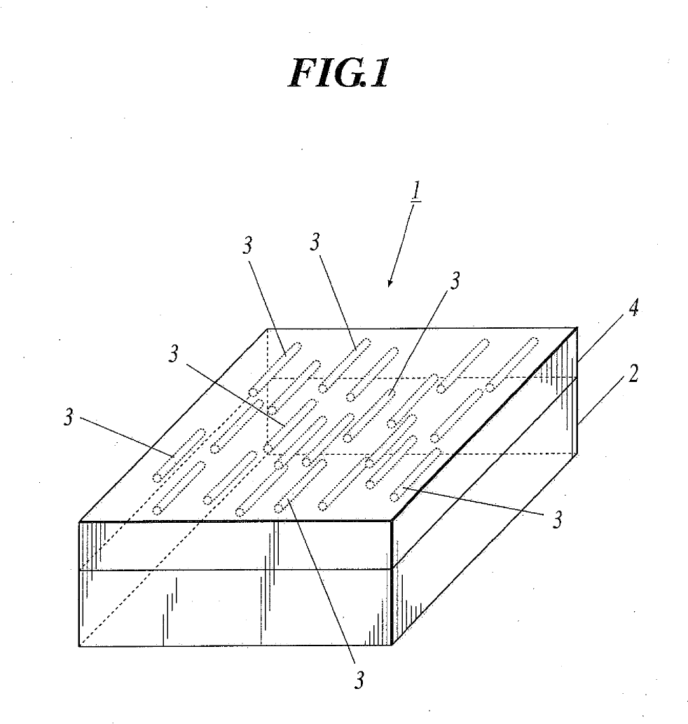

FIG. 1 is a perspective view showing a schematic structure of light emitting body 1 according to the first embodiment.

As shown in FIG. 1, the light emitting body 1 is provided with a substrate 2 that has a rectangular shape. A film dispersed of carbon nanotubes 4 which has a plurality of carbon nanotubes 3, 3, . . . dispersed is formed on the substrate 2.

As for the substrate 2, material with any property among insulating property, conductive property, and semi-conductive property can be applied. For example, materials such as quartz, glass, quartz glass, ceramics, metal, silicone, and the like can be used. In a case where the substrate 2 is structured with glass, it is preferable to use transparent glass such as soda-lime glass, low soda glass, lead-alkali-silicate glass, borosilicate glass, and the like. In particular, it is preferable to structure the substrate 2 with a high strain point low soda glass and low soda glass. In a case where the substrate 2 is structured with ceramics, alumina, zirconia, titania, silicon nitride, silicon carbide, and the like can be used.

The substrate 2 may be structured with plastic film. As for the material of the plastic film, polyolefins such as polyethylene, polypropylene, and the like, vinyl polymers such as polyvinyl acetate, polyvinyl chloride, polystyrene, and the like, polyamides such as 6,6-nylon, 6-nylon, and the like, polyesters such as polyethylene terephthalate (hereinafter referred to as PET), polyethylene 2,6-naphthalene di-carboxylate (hereinafter referred to as PEN), and the like, cellulose esters such as poly carbonate, cellulose tri-acetate (hereinafter referred to as TAC), cellulose di-acetate, and the like, can be mentioned.

Among the afore-mentioned materials for plastic film, it is preferable to use PET, PEN, and TAC that are used as polyester for photographs.

Here, various kinds of surface treatments such as those disclosed in Japanese Patent Publication No. Tokukaihei 9-108613 may be applied to the substrate 2.

The film dispersed of carbon nanotubes 4 according to the present invention is a film in which each carbon nanotube 3 is dispersed. Each carbon nanotube 3 is dispersed isolatedly in the film dispersed of carbon nanotubes 4, and it is further dispersed in a state in which they are oriented in a certain direction in the film dispersed of carbon nanotubes A.

The “carbon nanotubes 3, 3, . . . ” indicates an aggregate of carbon that has fiber diameter (D) of approximately 1-1,000 nm, length (L) of 0.1-1,000 μm, a large aspect ratio with L/D of approximately 100-10,000, and is shaped in a tubular shape. The carbon nanotubes 3, 3, . . . can be prepared by methods such as arc discharge method, laser adsorption method, catalytic chemical vapor deposition method, and the like. Manufacturing methods are disclosed in Yahachi Saito and Shunnji Bando, “Basics of Carbon Nanotube” published from Corona Publishing CO., LTD, and the like.

An ordinary carbon nanotube has two types, “single-walled carbon nanotube” and “multi-layer carbon nanotube”. The single-walled carbon nanotube is a tube with a thickness of single atom layer, which is one sheet of graphene (single atom layer of hexagonal carbon net surface) closed in a shape of cylinder. As for the carbon nanotubes 3, 3, . . . , any type among single-walled or multi-layer can be applied so long as it is what is called carbon nanotube. However, it is preferable to use single-walled carbon nanotube as the carbon nanotubes 3, 3, . . . .

As for carbon nanotubes 3, 3, . . . that are in practical use, single-walled carbon nanotube prepared by High Pressure CO (HiPco) method (available from Carbon Nanotechnologies, INC.), as well as carbon nanotube prepared by Alcohol Catalytic Chemical Vapor Deposition (ACCVD) method can be used preferably. In addition, Graphite fibril (registered trademark) from Hyperion Corporation, products of Showa Denko K.K, Pyrograf III (registered trademark) from ASISH, and the like can be used. Needless to say, carbon nanotube 3 is not limited to these.

Carbon nanotubes 3, 3, . . . are not limited to carbon product, and may be a BN (boron nitiride) nanotube in which carbon is partly or wholly replaced with Boron and Nitrogen, and the like, for example.

The film dispersed of carbon nanotubes 4 is prepared, by coating a coating solution, which is a solution mixture prepared by agitating/mixing a solution of the afore-mentioned plurality of carbon nanotubes 3, 3, . . . , surfactant, solvent, and the like, with a transparent binder, on the substrate 2. Additives such as hardener may be added to the coating solution.

Hereinafter, applicable surfactant, solvent, transparent binder, and hardener are described in detail.

### (Surfactant)

As for the surfactant, any one among anionic surfactant, nonionic surfactant, cationic surfactant, and dipolar surfactant may be used. Preferably, anionic surfactant such as alkyl sulfonate, alkyl benzene sulfonate, alkyl naphthalene sulfonate, alkyl sulfate, sulfo succinate, sulfo alkyl polyoxyethylene alkyl phenyl ether, N-acyl N-alkyl taurine, and the like, and nonionic surfactant such as saponin, alkylene oxide derivatives, alkyl esters of sugar, and the like, are used.

As for the surfactant, fluorine containing surfactant can also be used preferably. As for example, fluorine containing alkyl anion surfactant, fluorine containing alkyl cationic surfactant, fluorine substituted alkylene oxide surfactant, perfluoro cycloalkane surfactant, and the like can be mentioned.

### (Solvent)

As for the solvent, starting with water such as deuterated water, aliphatic hydrocarbons such as heptane, petroleum benzine, cyclohexane, and the like, aromatic hydrocarbons such as benzene, xylene, ethyl benzene, and the like, halogenated hydrocarbons such as methylene chloride, carbon tetra chloride, tri chloro ethane, and the like, alcohols such as methanol, ethanol, n-propanol, and the like, ethers such as ethyl ether, tetrahydrofurane, and the like, ketones such as methyl ethyl ketone, cyclohexanone, and the like, esters such as methyl formate, n-propyl acetate, and the like, derivatives of polyols such as ethylene glycol mono ethyl ether and the like, aliphatic acids such as acetic acid, phenols, and Compounds including nitrogen or sulfur can be used as the solvent. These solvents may be used alone, or may be used as a mixture of two or more of these.

### (Transparent Binder)

As for the transparent binder, gelatin can be used preferably. Such gelatin is manufactured from beef bones, cow skin, pig skin, and the like as raw material. Concerning the manufacturing process from collagen, there is alkali treated gelatin that involves treatment with lime and the like, and acid treated gelatin that involves treatment with hydrochloric acid. Gelatin applied as one component of the coating solution may be either of these.

Details on Manufacturing method and property of these gelatin are disclosed in Arthur Veis, “The Macromolecular Chemistry of Gelatin”, pp. 187-217, 1964, Academic Press; T. H. James, “The Theory of the photographic Process”, 4^{th} ed. P. 55, 1977, Macmillan; “Glue and Gelatin”, Japan Glue and Gelatin Association, 1987; “Basics of Photographic Engineering—silver halide photography”, pp. 119-124, Corona Publishing CO., LTD, and the like.

It is preferable that jelly strength (according to PAGI method) of gelatin is 250 g or more. It is preferable that calcium content (according to PAGI method) of gelatin is 4000 ppm or less, and particularly preferable to be 3000 ppm or less.

As for the gelatin, alkali treated gelatin, acid treated gelatin, oxidized gelatin, and enzyme treated gelatin such as those disclosed in Bull. Soc. Sci. Photo. Japan. No. 16. p. 30 (1966), with molecular weight of approximately 100 thousand can be used preferably in general. Further, chemically modified gelatin can be also used preferably. As for the chemically modified gelatin, gelatin with its amino group substituted, such as those disclosed in Japanese Patent Publication No. Tokukaihei 5-72658, Japanese Patent Publication No. Tokukaihei 9-197595, Japanese Patent Publication No. Tokukaihei 9-251193, and the like can be mentioned.

It is preferable that methionine content of the gelatin is less than 30 μmol/g, more preferable that it is less than 20 μmol/g, and further preferable that it is 0.1-10 μmol/g. In order to decrease the methionine content of gelatin to less than 30 μmol/g, oxidation of alkali treated gelatin by oxidant is effective. As for the oxidant that can be used for oxidation of gelatin, hydrogen peroxide, ozone, peroxy acid, halogen, thio sulfonic compound, quinones, and organic peroxides can be mentioned. However, it is preferable to use hydrogen peroxide. There are many literatures that describe method to measure methionine content of gelatin. For example, Journal of Photographic Science, vol. 28, p. 111; vol. 40, p. 149 of the same; vol. 41, p. 172 of the same; vol. 42, p. 117 of the same; Journal of Imaging Science,. vol. 33, p. 10; Journal of Imaging Science and Technology, vol. 39, p. 367; and the like can be mentioned. By referring to these literatures, methionine content of gelatin can be measured by amino acid analysis method, High Performance Liquid Chromatography (HPLC) method, gas chromatography method, silver ion titration method, and the like.

In addition, as the transparent binder, other than the afore-mentioned gelatin, proteins such as gelatin derivatives, graft polymer of gelatin and other polymer, albumin, casein, and the like; cellulose derivatives such as hydroxyl ethyl cellulose, carboxy methyl cellulose, cellulose sulfate, and the like; sugar derivatives such as sodium alginate, starch derivatives, and the like; various kinds of synthetic and semi-synthetic hydrophilic polymer substances such as poly vinyl alcohol, poly vinyl alcohol partially acetal, poly vinyl pyrrolidone, poly acrylic acid, poly acrylamide, poly methacrylic acid, poly vinyl imidazole, poly vinyl pyrazole, and the like; can be applied.

### (Hardener)

Hardener is a substance that is capable to harden the transparent binder with the afore-mentioned gelatin in the center, and is capable to adjust swelling rate, film strength, and the like by its quantity. It is preferable since each carbon nanotube 3 can be stably maintained isolatedly and in an oriented state. As for the hardener, organic hardeners such as aldehydes (formaldehyde, glyoxal, glutaraldehyde, and the like), mucohalogenic acids (mucochloric acid, mucophenoxychloric acid, and the like), epoxy compounds, active halogen compounds (2,4-dichloro-6-hydroxy-s-triazine and the like), active vinyl derivatives (1,3,5-triacryloyl hexahydro-s-triazine, bis(β-vinyl sulfonyl)methyl ether, N,N′-methylene bis sulfonyl(propion amide))), and the like), ethylene imines, carbodiimides, methane sulfonic acid esters, iso oxazoles; inorganic hardeners such as chrome alum; polymer hardeners such as those disclosed in U.S. Pat. Nos. 3,057,723, 3,396,029, and 4,161,407; and the like can be used. These hardeners may be used alone, or may be used as a combination of two or more of these.

Here, though it is not shown in FIG. 1, overcoat film for the purpose to smoothen the surface of the film dispersed of carbon nanotubes 4 may be formed on the film dispersed of carbon nanotubes 4. The overcoat film is preferably formed by a well known coating method, and it is preferable that it is composed of substrates, which are carbon nanotubes 3, 3, . . . eliminated from the coating solution that compose the film dispersed of carbon nanotubes 4.

Next, manufacturing method of the light emitting body 1 and the film dispersed of carbon nanotubes 4 will be described.

First of all, a carbon nanotube dispersion solution is prepared by adding the afore-mentioned carbon nanotubes 3, 3, . . . and additives such as surfactants to the solvent (preparation step). For example, in a case where a single-walled carbon nanotube formed by HiPco method is used as the carbon nanotube 3, 3, . . . , Sodium Dodecyl Sulfate (SDS) is used as surfactant, and deuterium water is used as solvent, a plurality of carbon nanotubes 3, 3, . . . and surfactant is added to the solvent, thus carbon nanotube containing solution is prepared.

Subsequent to preparation of the carbon nanotube containing solution, dispersion processing and ultracentrifuge processing is applied to the carbon nanotube containing solution in this order (dispersion step, separation step). Clear upper portion is collected from the carbon nanotube containing solution after ultracentrifuge (extraction step), and a carbon nanotube dispersion solution, in which each carbon nanotube 3, 3, . . . is dispersed in the solvent, is obtained.

Concerning dispersion processing of the dispersion step, agitation processing, ultrasonic processing, and the like that are widely known, can be mentioned. Concerning dispersing device used for processing in the dispersion step, high speed agitation dispersing device that has large shear force, a dispersing device that applies ultrasonic energy of high strength, and the like, can be mentioned. In particular, the dispersing device is an emulsifier and the like provided with a colloid mill, a homogenizer, a capillary type emulsifier, a liquid siren, an electromagnetic strain type ultrasonic generator, and a Poleman whistle. Preferable high speed agitation dispersing device used in the dispersion step are dissolver, polytron, homomixer, homoblender, kedi mill, jet agitator, and the like, of which the substantial portion for dispersion rotates with high speed in liquid (500-15,000 rpm, preferably 2,000-4,000 rpm). The high speed agitation dispersing device is also called dissolver or high speed impeller dispersing device, and as the one disclosed in Japanese Patent Publication No. Tokukaisho 55-129136, the one provided with an impeller, whose saw-toothed blade is bent in up and down direction alternatively, to the axis that rotate with high speed, is a preferable example for the high speed agitation dispersing device.

After dispersion step, separation step, and extraction step are concluded, the carbon nanotube dispersion solution and the transparent binder are mixed, and each carbon nanotube 3, 3, . . . is agitated in the transparent binder (agitation step).

In the agitation step, in a case where gelatin is used as the transparent binder for example, gelatin (or gelatin solution) is added to the carbon nanotube dispersion solution. Dissolution of gelatin is conducted by first swelling at ambient temperature for a predetermined time and then heating, or is conducted by heating immediately after addition. In addition, dispersion processing of the afore-mentioned dispersion step may be applied again as in need.

As described, the transparent binder is dissolved in the carbon nanotube dispersion solution, and thus carbon nanotube dispersion coating solution for the coating step described later is obtained.

Here, the carbon nanotube dispersion coating solution structures the film dispersed of carbon nanotubes 4 in the later processing, however, the carbon nanotube dispersion coating solution may be added with the afore-mentioned hardener before coating, for the purpose of hardening the film dispersed of carbon nanotubes 4.

After the agitation step is concluded, the carbon nanotube dispersion coating solution is dropped onto the substrate 2, and coating processing of the known wire bar method is conducted to the carbon nanotube dispersion coating solution (coating step). That is, the carbon nanotube dispersion coating solution is dropped on the substrate 2 in a substantially parallel direction with respect to the wire bat, which has a fine piano wire, stainless wire, and the like that has diameter of several to several hundred μm winded around the rod. The wire bar is moved (scanned) in a predetermined speed with respect to the carbon nanotube dispersion coating solution to widely spread the carbon nanotube dispersion coating solution in the moving direction, and thus film dispersed of carbon nanotubes 4 is formed onto the substrate 2.

As a result, each carbon nanotube 3 in the carbon nanotube dispersion coating solution is dispersed isolatedly (in an isolated state) in the carbon nanotube dispersion coating solution, and is oriented in a certain direction that is along the moving direction of the wire bar.

In the coating step, the wire bar may be moved in a state that the substrate 2 is fixed, the substrate 2 may be moved in a state that the wire bar is fixed, or the substrate 2 and the wire bar may be both moved in opposite direction with each other. The larger the relative moving speed of one against the other among the substrate 2 and the wire bar (spreading speed), it is more preferable. Preferably, the relative moving speed is 5 times or more, more preferably 10 times or more, and further preferably 50 times or more.

Here, in the coating step, shear stress is applied not only in the moving direction of the substrate 2 or the wire bar, but also in the direction that is orthogonal to the moving direction. Therefore, each carbon nanotube 3 is oriented in the moving direction and inside the film.

After the coating step is concluded, the film dispersed of carbon nanotubes 4 is hardened (hardening step). In the hardening step, it is preferable to harden the film dispersed of carbon nanotubes 4 on the substrate 2 rapidly. In a case where the time that the film dispersed of carbon nanotubes 4 is maintained in a liquid state is long, fluidization phenomenon such as dripping, labeling, and the like occurs, and not only the orientation of each carbon nanotube 3 is disordered, but also homogeneity as a coating film cannot be maintained. Therefore, it is required to immediately suppress or eliminate flowability of the film dispersed of carbon nanotubes 4, immediately after the carbon nanotube dispersion coating solution is coated.

As for the method to harden the film dispersed of carbon nanotubes 4, although it differs according to the transparent binder that is used, in a case where gelatin is used as the transparent binder, it can be easily turned into a gel, by cooling the carbon nanotube dispersion coating solution immediately after coating and decreasing the temperature of the coating solution. That is, after the carbon nanotube dispersion coating solution is coated on the substrate 2 by the afore-mentioned method as described in the coating step, film surface (surface of film) of the film dispersed of carbon nanotubes 4 is cooled to 20 degrees Celsius or lower, preferably to 15 degrees Celsius or lower, and more preferably to 10 degrees Celsius or lower.

Cooling the film surface is achieved by letting the substrate 2 with the carbon nanotube dispersion coating solution coated, go through an atmosphere that is maintained at the afore-mentioned temperature. The time in which it is maintained at this temperature varies according to the temperature of the carbon nanotube dispersion coating solution, film thickness of the film dispersed of carbon nanotubes 4 in a swelled state before the hardening step, thickness of the substrate 2, and the like. In a case where the temperature of the carbon nanotube dispersion coating solution immediately after being coated on the substrate 2 is in a temperature range of an ordinary coating solution (35 to 50 degrees Celsius), the cooling time is usually set to 1-100 seconds, preferably 5-50 seconds. Thus, flowability of coating film of the film dispersed of carbon nanotubes 4 can be made small immediately, and orientation of each carbon nanotube 3 is not disordered, and the film dispersed of carbon nanotubes 4 can be made homogenized as the coating film.

Here, concerning hardening of the film dispersed of carbon nanotubes 4 in the hardening step, any method can be applied so long as it can harden the film dispersed of carbon nanotubes 4 after coating the carbon nanotube dispersion coating solution rapidly. For example, a known method that uses various kinds of hardening resin such as Ultra Violet (UV) hardening resin, thermosetting resin, and the like, can be applied. In addition, processing in the hardening step may not harden the film dispersed of carbon nanotubes 4, but increase its viscosity so that flow of the film dispersed of carbon nanotubes 4 is suppressed to required minimum.

After the hardening step is concluded, the film dispersed of carbon nanotubes 4 is dried (drying step). The drying step is a step to remove solvent from the film dispersed of carbon nanotubes 4, and it is required to dry the film dispersed of carbon nanotubes 4 without disrupting the alignment of the oriented each carbon nanotube 3. Therefore, in a case where gelatin is used as the transparent binder, it is preferable to dry the film dispersed of carbon nanotubes 4 under low temperature so that the gelatin maintains a gel state in the low temperature. In addition, in a case where only the flowability of the film dispersed of carbon nanotubes 4 was decreased in the hardening step, it is preferable to dry the film dispersed of carbon nanotubes 4 under low temperature so that its flowability does not increase.

Concerning the drying step, it is preferable to dry the film dispersed of carbon nanotubes 4 by blowing a wind of 20-70 degrees Celsius to the film dispersed of carbon nanotubes 4. In such case, when the region of the film dispersed of carbon nanotubes 4 that was cooled is dried immediately at high temperature, three-dimensional structure of the film dispersed of carbon nanotubes 4, that was once structured, is disrupted and the flowability of the film dispersed of carbon nanotubes 4 increases, thus not only the orientation of each carbon nanotube 3 is disordered, but also the film dispersed of carbon nanotubes 4 becomes not homogenized as a coating film. Thus, it is usually preferable to set the drying temperature immediately after cooling to 50 degrees Celsius or lower.

It is preferable to set the humidity of the wind during the drying step in the range of 10-50% usually. After the film dispersed of carbon nanotubes 4 is dried completely, it is preferable to conduct humidity conditioning for a certain time (for example, 20-180 seconds), under the relative humidity of 30-70%.

By going through the afore-mentioned steps, light emitting body 1 according to the present invention, which is the film dispersed of carbon nanotubes 4 formed on the substrate 2, is obtained.

As described, according to the first embodiment, since each carbon nanotube 3 is dispersed isolatedly (in an isolated state) in the film dispersed of carbon nanotubes 4 (that is, in the transparent binder), it can absorb an excitation light with a particular wavelength and emit an intensive light with a particular wavelength.

For example, in a case where a single-walled carbon nanotube formed by HiPco method or ACCVD method is applied as carbon nanotubes 3, 3, . . . , it can absorb visible light and emit intensive near-infrared ray in a particular wavelength (refer to the following Examples 1 and 2). Therefore, in an event that reflecting mirror is arranged at both sides of the light emitting body 1 of this case as laser medium, it can function as light resonator (cavity). The light resonator can conduct induced irradiation with uniform phase repeatedly, with a simple structure. Further, it can oscillate laser with superior directivity. Further in this case, due to the characteristics that it absorbs visible light and emits intensive near-infrared ray, the light emitting body 1 (or the film dispersed of carbon nanotubes 4) according to the present invention can be applied to a wide field of optical communications field such as ultrahigh-speed optical communications and the like, and to medical field such as laser therapy and the like.

### Second Embodiment

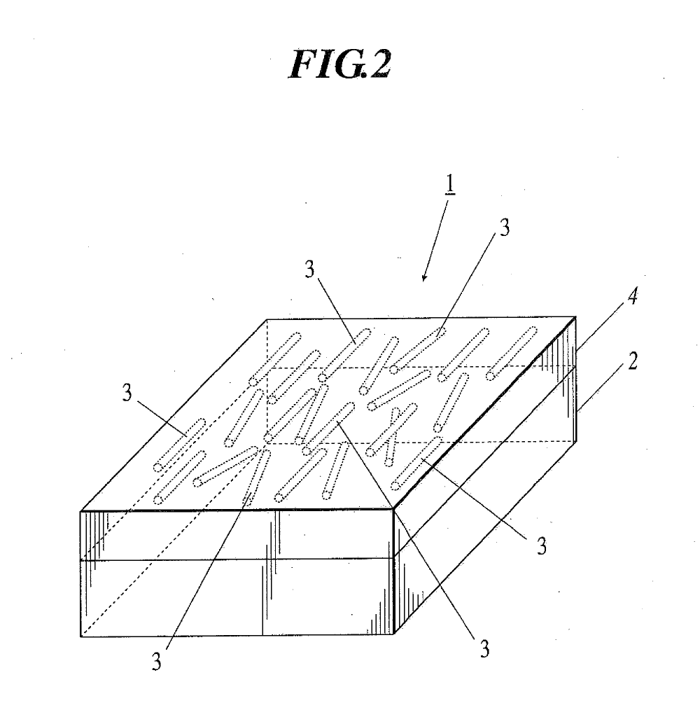

FIG. 2 is a perspective view showing a schematic structure of a light emitting body according to the second embodiment.

As shown in FIG. 2, the light emitting body 1 according the second embodiment differs from the light emitting body 1 according to the first embodiment, concerning the state of each carbon nanotube 3 in the film dispersed of carbon nanotubes 4. Other structure is the same as the first embodiment. That is, concerning the light emitting body 1 shown in FIG. 2, each carbon nanotube 3 is only dispersed isolatedly (in an isolated state) in the film dispersed of carbon nanotubes 4, and each carbon nanotube 3 is not oriented in a certain direction.

The manufacturing method of light emitting body 1 and the film dispersed of carbon nanotubes 4 according to the second embodiment are different from the manufacturing method of light emitting body 1 and the film dispersed of carbon nanotubes 4 according to the first embodiment in only a few steps, and other steps are the same as the first embodiment. That is, in the coating step, a coating processing of known wire bar method is conducted in a similar manner as mentioned above, however, since there is no need to make each carbon nanotube 3 oriented in a certain direction that is along the moving direction of the wire bar, a wire with thick diameter as mm order is used as wire that is winded around the rod. Further, the relative moving speed of one against the other among the substrate 2 and the wire bar (spreading speed), is the same as afore-mentioned or slower.

In addition, in this coating step, in addition to the afore-mentioned wire bar method, the processing may be conducted, by coating technique such as dip method, applicator method, extrusion method, slide bead method, curtain method, spray method, blade method, stripe method, bar coating method, slot method, slide method, gravure method, web tension method, air doctor method, and the like.

As described above, according to the second embodiment, since each carbon nanotube 3 is dispersed isolatedly (in an isolated state) in the film dispersed of carbon nanotubes 4 (that is, in the transparent binder), it can absorb an excitation light with a particular wavelength and emit light with a particular wavelength.

Here, in the second embodiment, a single-walled carbon nanotube that is formed by the ACCVD method is applied as the carbon nanotubes 3, 3, . . . . The single-walled carbon nanotube that is formed by the ACCVD method has a plurality of carbon nanotubes with a particular structure (chirality) alternatively. As a result, it can absorb visible light, and emit intensive tear-infrared ray in a region of particular wavelength (refer to the following Example 3). Therefore, in a similar manner as the afore-mentioned first embodiment, it can provide a novel light resonator that can replace the known light resonator, and further be applied widely to optical communication field and to medical field.

### Example 1

### (1) Preparation of Test Sample A

To a D₂O solution which was prepared by adding 100 mg of SDS to 10 g of D₂O, 15 mg of known single-walled carbon nanotube formed by HiPco method was added to obtain HiPco containing solution. After the HiPco containing solution was obtained, ultrasonic processing was applied to the HiPco containing solution by a horn sonicator, for one hour within water-cooling at 10-15 degrees Celsius with output of 400 W.

After the ultrasonic dispersion processing was concluded, ultracentrifuge processing was applied to the HiPco containing solution after ultrasonic dispersion processing, with 330,000 g (plus minus 50,000 g) of load under 22 degrees Celsius for one hour. After the ultracentrifuge processing was concluded, upper 30% and lower 30% (including precipitation) was eliminated from the clear upper portion of the HiPco containing solution after ultracentrifuge processing, and the central 40% of the clear upper portion was collected to obtain HiPco dispersion solution.

After the HiPco dispersion solution was obtained, 0.33 g of gelatin derived from beef bones, manufactured by Wako Pure Chemical Industries, LTD., was added to 3 g of the HiPco dispersion solution, and was left at ambient temperature for approximately 10 minutes, to let the gelatin swell thoroughly. After the gelatin swelled, the solution mixture was heated to 52 degrees Celsius for approximately 5-10 minutes and was agitated and mixed thoroughly. Subsequently, ultrasonic processing by a bath-type sonicator was applied to the solution mixture for three minutes, and thus HiPco dispersion coating solution was obtained.

After the. HiPco dispersion coating solution was obtained, a quartz glass substrate with the size of 25 mm×25 mm, 25 mm thickness, and its surface optically polished, was prepared. Under room temperature, HiPco dispersion coating solution was dropped by a dropper on the surface of the quartz class substrate, parallel to the wire bar. The HiPco dispersion coating solution on the quartz glass substrate was left in that state for 1 minute to increase viscosity.

After one minute passed, under room temperature, a wire bar, which has a wire of 100 μm diameter winded around a stainless rod of 6 mm diameter, was moved with a speed of approximately 2 m/sec, with respect to the HiPco dispersion coating solution that was dropped on the quartz glass substrate. Thus, each carbon nanotube in the HiPco dispersion solution was oriented in the direction that is along the moving direction of the wire bar. After the HiPco dispersion coating solution was coated, the quartz glass substrate was loaded on a metal plate and cool wind was applied, to the coated HiPco dispersion coating solution, the coated HiPco dispersion coating solution is dried within cooling from the both upper and lower sides, and thus a dispersion film including a carbon nanotube was formed.

Taking these coating/drying processing by the wire bar as one cycle, the coating processing was repeated for five times in total, and the film dispersed of carbon nanotubes was formed on the quartz glass substrate. In this state, the surface of the film dispersed of carbon nanotubes showed bumpiness of the lines of wire bar.

After the film dispersed of carbon nanotubes was formed, two layers of overcoat films were formed on the film dispersed of carbon nanotubes for the purpose of smoothing the surface of the film dispersed of carbon nanotubes and to make the film dispersed of carbon nanotubes transparent.

That is, gelatin solution was obtained by adding gelatin derived from beef bone, manufactured by Wako Pure Chemical Industries, LTD., to the D₂O solution which was prepared by adding 30 mg of SDS to 3 g of D₂O, so that gelatin would make 11% concerning the percentage by weight as a whole. The gelatin solution was dropped on the film dispersed of carbon nanotubes by a dropper as a coating solution in a parallel direction with respect to the wire bar. The wire bar, which has a wire of mm order winded around a stainless rod, was moved with a speed slower than 2 m/sec, and thus gelatin solution was coated on the film dispersed of carbon nanotubes.

After the gelatin solution was coated, the quartz glass substrate was loaded on a metal plate and cool wind was applied to the coated gelatin solution, the coated gelatin solution as well as the film dispersed of carbon nanotubes were dried within cooling from both upper and lower sides, and thus overcoat film of gelatin solution was formed. By repeating such coating/drying processing again, two layers of overcoat film was formed on the film dispersed of carbon nanotubes, and was referred to as “test sample A”.

### (2) Measurement of Polarized Absorption Spectrum of Test Sample A

By using a spectroscope of UV-3150 manufactured by Shimadzu Corporation, polarized absorption spectrum of the test sample A was measured in a state where light polarizer was placed in between the light source and the test sample A. Here, measurement of the polarized absorption spectrum was conducted for two cases, a case where linear polarization in a direction that is along orientation direction of each carbon nanotube in the test sample A (a direction that corresponds to the moving direction of the wire bar) was conducted, and in a case where linear polarization in a direction that is orthogonal to the orientation direction was conducted.

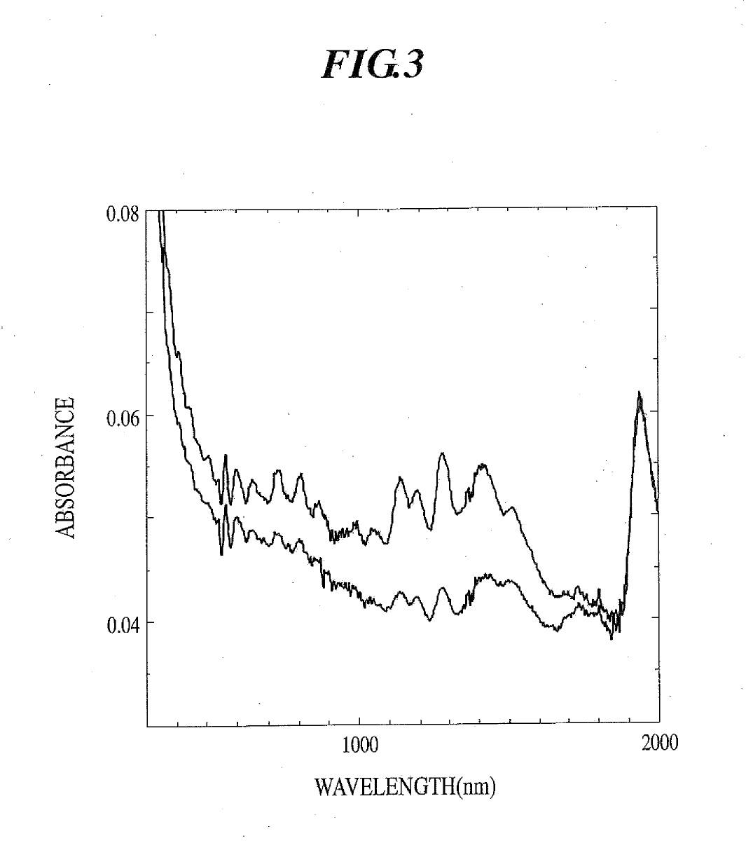

Result of measurement of polarized absorption spectrum of the test sample A is shown in FIG. 3. In FIG. 3, the upper solid line indicates a polarized absorption spectrum when linear polarization in a direction along the orientation direction of each carbon nanotube in the test sample A was conducted, and the lower solid line indicates a polarized absorption spectrum when linear polarization in a direction orthogonal to the orientation direction of each carbon nanotube in the test sample A was conducted.

Concerting the two polarized absorption spectrums shown in FIG. 3, each peak around the wavelength of 500-900 nm and 1000-1500 nm correspond to each carbon nanotube in the film dispersed of carbon nanotubes. Since significant difference in absorption can be seen in the same wavelength, concerning each peak of the upper polarized absorption spectrum and each peak of the lower polarized absorption spectrum, in can be understood that each carbon nanotube is oriented in a certain direction that is along the moving direction of the wire bar.

### (3) Measurement of Fluorescence Spectrum of Test Sample A

By using a spectroscope of Jobin Yvon manufactured by Horiba Ltd., fluorescence spectrum of the test sample A was measured in a state where slit plate with slit width of 13 nm was placed in the light entering side and the light exiting side respectively. Here, measurement of the fluorescence spectrum was conducted for two cases, a case where light with wavelength of 650 nm was irradiated to the test sample A as the excitation light, and a case where light with wavelength of 720 nm was irradiated to the test sample A as the excitation light.

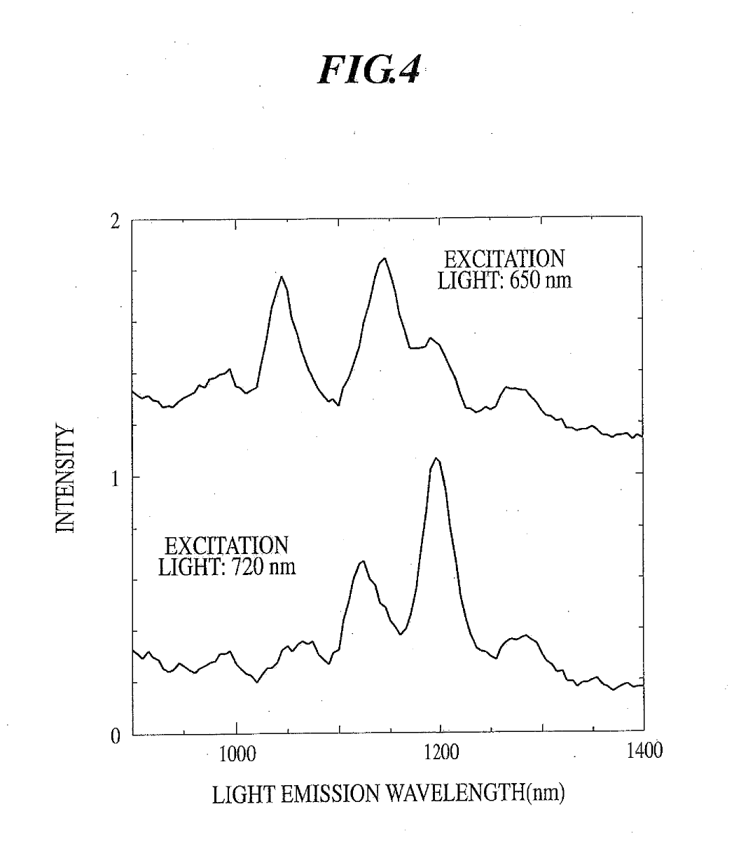

Result of measurement of fluorescence spectrum of the test sample A is shown in FIG. 4. In FIG. 4, the upper solid line indicates a fluorescence spectrum when excitation light of 650 nm was irradiated to the test sample A, and the lower solid line indicates a fluorescence spectrum when excitation light of 720 nm was irradiated to the test sample A.

Concerning the fluorescence spectrum shown in upper portion of FIG. 4, peak of emission light with wavelength around 1050 nm corresponds to carbon nanotube with chiral vector of (7, 5), and peak of emission light with wavelength around 1150 nm corresponds to carbon nanotube with chiral vector of (7, 6). From the existence of each peak of emission light with wavelength around 1050 nm and around 1150 nm, it can be understood that in a case where visible light with wavelength of 650 nm is irradiated as the excitation light to the film dispersed of carbon nanotubes according to the present invention, as supposed by the test sample A, near-infrared ray with wavelength of 1050 nm and 1150 nm are emitted.

Concerning the fluorescence spectrum shown in lower portion of FIG. 4, peak of emission light with wavelength around 1120 nm corresponds to carbon nanotube with chiral vector of (9, 4), and peak of emission light with wavelength around 1200 nm corresponds to carbon nanotube with chiral vector of (8, 6). From the existence of each peak of emission light with wavelength around 1120 nm and around 1200 nm, it can be understood that in a case where visible light with wavelength of 7200 nm is irradiated as the excitation light to the film dispersed of carbon nanotubes according to the present invention, as supposed by the test sample A, near-infrared ray with wavelength of 1120 nm and 1200 nm are emitted. Thus, it is understood that each carbon tube in the dispersion film is dispersed isolatedly (in an isolated state).

### Example 2

### (1) Preparation of Test Sample B

A known single-walled carbon nanotube formed by ACCVD method was used in place of the afore-mentioned single-walled carbon nanotube formed by HiPco method, arid the rest was carried out in the same manner as the procedure (1) of the afore-mentioned Example 1, to prepare test sample. The test sample was referred to as “test sample B”.

### (2) Measurement of Polarized Absorption Spectrum of Test Sample B

Concerning the test sample B, polarized absorption spectrum was measured in the same manner as the procedure (2) of the afore-mentioned Example 1. Though result of measurement of polarized absorption spectrum of the test sample B is not shown, concerning the polarized absorption spectrum of the test sample B, significant difference in absorption was observed for each peak around the wavelength of 500-900 mm, and 1000-1500 nm. Therefore, each carbon nanotube in the film dispersed of carbon nanotubes was oriented in the test sample B, in a similar manner as the test sample A. However, concerning the polarized absorption spectrum of the test sample B, number of peak was less compared to the number of peak of the test sample A, and absorption Of each peak was larger than the absorption of peak of the test sample A. Therefore, it is understood that carbon nanotube with a certain chirality exists in a larger amount in the film dispersed of carbon nanotubes of the test sample B, than that of the test sample A.

### (3) Measurement of Fluorescence Spectrum of Test Sample B

Concerning the test sample B, fluorescence spectrum was measured in the same manner as described in procedure (3) of the Example 1. Though result of measurement of fluorescence spectrum of the test sample B is not shown, concerning the fluorescence spectrum of the test sample B, number of peak was less than the number of peak of the test sample A, and intensity of each peak was larger than the intensity of peak of the test sample A. Therefore, it is understood that near-infrared ray of a particular wavelength can be emitted with more intensity, when single-walled carbon nanotube formed by ACCVD method is dispersed, compared to when single-walled carbon nanotube formed by HiPco method is dispersed.

### Example 3

### (1) Preparation of Test Sample C

A known single-walled carbon nanotube formed by ACCVD method was used in place of the afore-mentioned single-walled carbon nanotube formed by HiPco method, and diameter of wire was replaced with the one with the order of mm in the coating step, and the wire bar was moved with a speed slower than the moving speed of wire bar with 2 m/sec. The rest was carried out in the same manner as the procedure (1) of the afore-mentioned Example 1, to prepare test sample. The test sample is referred to as “test sample C”.

### (2) Measurement of Polarized Absorption Spectrum of the Test Sample C

Concerning the test sample C, polarized absorption spectrum was measured in the same manner as the procedure (2) of the afore-mentioned Example 1. Though result of measurement of polarized absorption spectrum of the test sample C is not shown, concerning the polarized absorption spectrum of the test sample C, difference in absorption was hardly observed for each peak around the wavelength of 500-900 mm, and 1000-1500 nm. Therefore, each carbon nanotube in the film dispersed of carbon nanotubes was not oriented in the test sample C.

### (3) Measurement of Fluorescence Spectrum of the Test Sample C

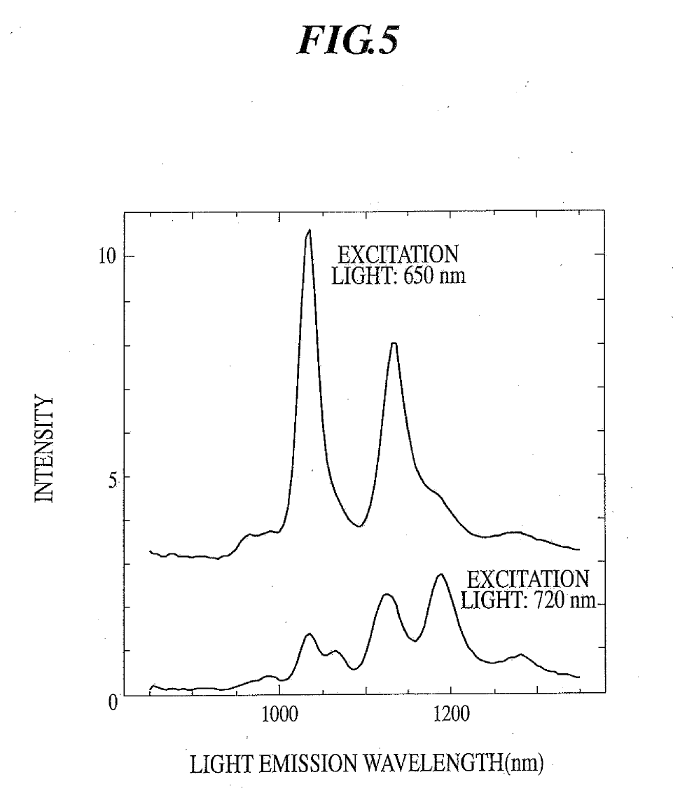

Concerning the test sample C, fluorescence spectrum was measured in the same manner as described in procedure (3) of the Example 1. Result of measurement of fluorescence spectrum of the test sample C is shown in FIG. 5. Concerning the fluorescence spectrum of the test sample C, in a similar manner as the fluorescence spectrum of the test sample A, peak that corresponds to chiral vectors (7, 5), (7, 6), (9, 4), and (8, 6) exists respectively. From the existence of these peaks, it can be understood that even though each carbon nanotube is not oriented in the film dispersed of carbon nanotubes, when they are dispersed isolatedly (in an isolated state), it can absorb visible light with wavelength of 650 nm and 720 nm as excitation light and emit near-infrared ray,

### INDUSTRIAL APPLICABILITY

The present invention can be applied widely to optical communication field such as ultrahigh-speed optical communication device and the like, and medical field such as laser therapy and the like.

1-10. (canceled)

11. A method for forming a film of dispersed carbon nanotubes comprising a plurality of carbon nanotubes dispersed in a transparent binder wherein each of the carbon nanotubes is dispersed isolatedly in an oriented manner, comprising:
coating a substrate with a carbon nanotube dispersion coating solution;
cooling the carbon nanotube dispersion coating solution on the substrate; and
drying the carbon nanotube dispersion coating solution on the substrate to form the film of dispersed carbon nanotubes.

12. The method of claim 1, wherein the carbon nanotubes are single-walled carbon nanotubes.

13. The method of claim 1, wherein the carbon nanotubes are single-walled carbon nanotubes that are formed by ACCVD method.

14. The method of claim 1, wherein the transparent binder is gelatin.

15. The method of claim 1, wherein the film of dispersed carbon nanotubes emits light.

16. A method for forming a light emitting body comprising forming the film of dispersed carbon nanotubes which are formed by the method of claim 1 on a substrate.

17. A method for forming a film of dispersed carbon nanotubes comprising a plurality of carbon nanotubes, each of the plurality of carbon nanotubes being dispersed isolatedly in a transparent binder, wherein the carbon nanotubes are single-walled carbon nanotubes that are formed by ACCVD method, comprising:
coating a substrate with a carbon nanotube dispersion coating solution;
cooling the carbon nanotube dispersion coating solution on the substrate; and
drying the carbon nanotube dispersion coating solution on the substrate to form a film of dispersed carbon nanotube.

18. The method of claim 7, wherein the transparent binder is gelatin.

19. The method of claim 7, wherein the film of dispersed carbon nanotubes emits light.

20. A method of forming a light emitting body comprising forming the film of dispersed carbon nanotubes which is formed by the method of claim 7 on a substrate.

21. The method of claim 1, wherein the carbon nanotube dispersion coating solution is cooled to 20° C. or below in the cooling.

22. The method of claim 7, wherein the carbon nanotube dispersion coating solution is cooled to 20° C. or below in the cooling.
